(19) United States
(12) Patent Application Publication
(10) Pub. No.: US 2018/0343896 A1
(43) Pub. Date: Dec. 6, 2018

(54) ANIMAL FEED PRODUCT

(71) Applicant: Dr D's Tasty Treats Ltd, Godalming (GB)

(72) Inventor: Heather DANIELL, London (GB)

(21) Appl. No.: 16/059,594

(22) Filed: Aug. 9, 2018

Related U.S. Application Data
(63) Continuation of application No. PCT/GB2017/050026, filed on Jan. 6, 2017.

(30) Foreign Application Priority Data
Feb. 11, 2016 (GB) 1602494.5

(51) Int. Cl. A23K 50/42; A23K 40/20; A23K 10/30; A23K 10/20

(52) U.S. Cl. CPC A23K 50/42; A23K 40/20; A23K 40/30; A23K 10/20; A23K 10/30

(57) ABSTRACT

Methods of producing animal feed products are described. The methods include treating an intact or unrefined plant material comprising at least one hydrocolloid precursor with an aqueous solvent to extract hydrocolloid precursor and thereby provide a hydrocolloid system and a plant material residue, mixing the hydrocolloid system containing the plant material residue with feed component to provide a feed mixture, forming the feed mixture into a product shape, and drying the product shape to provide the animal feed product.

### CROSS-REFERENCE TO RELATED APPLICATIONS

This application is a continuation of International Application No. PCT/GB2017/050026, filed Jan. 6, 2017, which claims priority to GB Application No. 1602494.5, filed Feb. 11, 2016, under 35 U.S.C. § 119(a). Each of the above-referenced patent applications is incorporated by reference in its entirety.

### BACKGROUND OF THE INVENTION

### Field of the Invention

The present invention relates to an animal feed product, and methods of preparing animal feed products. In particular, the present invention relates to animal feed products with low starch, sugar (mono- or disaccharides) and/or gluten content.

### Description of the Related Technology

In order to provide animal feed products, feed components are usually bound together with a binder. Often, binders comprise starch (including modified starch), sugars (mono- or disaccharides), gluten, or synthetic binders such as poly vinyl alcohol (PVA) or lignosulfate. However, there are concerns that sugars and starches can contribute to health problems. Also, there is a consumer demand for gluten-free products, and for feed products with ingredients derived from natural sources. Accordingly, there is a need for methods of providing animal feed product with a low starch, sugar, and/or gluten content, and containing only ingredients derived from natural sources.

### SUMMARY

According to the present invention, there is provided:
1) a processed and formed animal feed product comprising a feed component which includes a meat component;

wherein the meat component is present in an amount of from 2 to 98% by dry weight of the animal feed product;

wherein the animal feed product has a starch content of from 0 to 10% by dry weight of the animal feed product, and has a moisture content of from 0 to 30% by weight; and wherein the animal feed product includes a whole-plant component derived from an intact or unrefined plant material comprising at least one hydrocolloid precursor.

According to another aspect of the invention, there is further provided:

2) An animal feed product according to 1), wherein the animal feed product comprises the said whole-plant component in an amount of from 0.1 to 20% by dry weight of the animal feed product.

3) An animal feed product according to any of 1) to 2), wherein the intact or unrefined plant material comprises at least one of: psyllium or other plantain, linseed, fenugreek, slippery elm, guar, marshmallow, liquorice, cactus, aloe vera, cassava, mallow, okra, chai, Irish moss, spinach, Chinese yam, kelp, verbascum, sundews, parthenium, butterwort, mulukhiyuh, hibiscus, locust bean, and tara, and mixtures thereof.

4) An animal feed product according to any of 1) to 3), wherein the intact or unrefined plant material comprises at least one of: fenugreek, linseed, liquorice, marshmallow, okra, psyllium, slippery elm, spinach, and mixtures thereof.

5) An animal feed product according to any of 1) to 4), wherein the meat component comprises sheep, cattle, swine, chicken, turkey, duck, white fish, salmon, mackerel, sardine, trout, herring, tuna, lobster, crab, or a combination thereof.

6) An animal feed product according to any of 1) to 5), wherein the feed component further comprises a non-meat component comprising at least one of: alfalfa meal, pasture grass, linseed, linseed oil, mint, blueberry, cranberry, apple, pear, spinach, broccoli, kale, short cut grass, Lucerne, hay, straw, oat fibre, beet pulp, pea, tomato, chicory, carrot, garlic, lentils, pumpkin, yam, any other fruits or vegetables, and vitamins and minerals, and mixtures thereof.

7) An animal feed product according to 6), wherein the non-meat component of the feed component consists essentially of vitamins and/or minerals.

8) An animal feed product according to any of 1) to 7), wherein the said whole-plant component comprises a non-starch polysaccharide.

9) An animal feed product according any of 1) to 8), wherein the animal feed product contains less than 5% mono- and disaccharides by dry weight.

10) A method of producing an animal feed product comprising:
(a) treating an intact or unrefined plant material comprising at least one hydrocolloid precursor with an aqueous solvent to extract hydrocolloid precursor and thereby provide a hydrocolloid system and a plant material residue;
(b) mixing the hydrocolloid system containing the plant material residue with feed component to provide a feed mixture;
(c) forming the feed mixture into a product shape, and
(d) drying the product shape to provide the animal feed product.

11) A method according to 10), wherein the hydrocolloid precursor is a non-starch polysaccharide.

12) A method according to any of 10) to 11), wherein the aqueous solvent essentially consists of water.

13) A method according to 12), wherein the treatment in step (a) is carried out at a temperature of from 25° C. to 150° C.

14) A method according to any of 10) to 13), wherein the plant material comprises at least one of: psyllium or other plantain, linseed, fenugreek, slippery elm, guar, marshmallow, liquorice, cactus, aloe vera, cassava, mallow, okra, chai, Irish moss, spinach, Chinese yam, kelp, verbascum, sundews, parthenium, butterwort, mulukhiyuh, hibiscus, locust bean, and tara, and mixtures thereof.

15) A method according to any of 10) to 14), wherein the plant material comprises at least one of: fenugreek, linseed, liquorice, marshmallow, okra, psyllium, slippery elm, spinach, and mixtures thereof.

16) A method according to any of 10) to 15), wherein the plant material is ground, micronized, cracked, rolled, or flaked.

17) A method according to any of 10) to 16), wherein the feed component comprises a non-meat component.

18) A method according to 17), wherein the non-meat component comprises at least one of: alfalfa meal, pasture grass, linseed, linseed oil, mint, blueberry, cranberry, apple, pear, spinach, broccoli, kale, short cut grass, Lucerne, hay, straw, oat fibre, beet pulp, pea, tomato, chicory, carrot, garlic, lentils, pumpkin, yam, any other fruits or vegetables, and vitamins and minerals, and mixtures thereof.

19) A method according to any of 17) to 18), wherein the feed component consists essentially of non-meat component.

20) A method according to any of 10) to 16), wherein the feed component comprises a meat component, the meat component comprising sheep, cattle, swine, chicken, turkey, duck, white fish, salmon, mackerel, sardine, trout, herring, tuna, lobster, crab, or a combination thereof.

21) A method according to 20), wherein the feed component consists essentially of meat component.

22) A method according to any of 10) to 16), wherein the feed component comprises a meat component and a non-meat component.

23) A method according to 22), wherein the non-meat component consists essentially of vitamins and/or minerals.

24) A method according to any of 20) to 23), wherein the meat component has a moisture content of from 0 to 90% by weight.

25) A method according to any of 20) to 24), wherein the meat component is raw.

26) A method according to any of 20) to 25), wherein the meat component comprises a plurality of meat component particles having a diameter, the mean average diameter being equal to or less than 3 mm.

27) A method according to any of 10) to 26), wherein step (c) comprises extruding the feed mixture to provide a product shape.

28) A method according to any of 10) to 26), wherein step (c) comprises pressing the feed mixture to provide a product shape.

29) A method according to any of 10) to 28), wherein step (d) is carried out at a temperature of from 25° C. to 150° C.

30) A method according to any of 10) to 29), wherein steps (a) and (b) are carried out simultaneously.

31) An animal feed product obtainable by the method according to 10), wherein the feed component comprises a meat component;

wherein the animal feed component comprises the meat component in an amount of from 2 to 98% by dry weight of the animal feed product;

wherein the animal feed product has a starch content of from 0 to 10% by dry weight of the animal feed product; and wherein the animal feed product has a moisture content of from 0 to 30% by weight.

32) A method of feeding a carnivorous animal comprising providing a processed and formed animal feed product and feeding said feed product to said animal;

the animal feed product comprising a feed component which includes a meat component;
wherein the meat component is present in an amount of from 2 to 98% by dry weight of the animal feed product;
wherein the animal feed product has a starch content of from 0 to 10% by dry weight of the animal feed product, and has a moisture content of from 0 to 30% by weight; and
wherein the animal feed product includes a whole-plant component derived from an intact or unrefined plant material comprising at least one hydrocolloid precursor.

### DETAILED DESCRIPTION OF CERTAIN INVENTIVE EMBODIMENTS

Unless otherwise specified, in the specification and claims, all percentages are percentages by weight and all temperatures are in degrees Centigrade (degrees Celsius). Where percentages are given in reference to multiple components, the percentage refers to the cumulative w/w percentage of those components combined.

One aspect of the present invention is a processed and formed animal feed product comprising a feed component and a whole-plant component.

‘Processed’ as used herein in relation to the animal feed product means that in the preparation of the animal feed product, the components of the animal feed product have been combined and treated (for instance, chemically and/or mechanically) to provide a composition with a greater degree of homogeneity than a combination of components which has not been treated thus.

‘Formed’ as used herein in relation to the animal feed product means that in the preparation of the animal feed product, an animal feed composition has undergone a shaping process to provide an animal feed product suitable for consumption by animals. Such forming may include moulding, pressing, deposition, extrusion, or a combination thereof. Forming may further include further cutting a moulded, pressed, deposited or extruded composition to provide an animal feed product shape.

‘Animal feed product’ refers to any product suitable for feeding to animals. ‘Animal’ refers to any non-human animal, such as fish, amphibians, reptiles, birds, and non-human mammals, in particular non-human mammals In some embodiments, the term ‘animal’ may refer to farmyard animals. In one embodiment, the term ‘animal’ may refer to horses. In other embodiments, the term ‘animal’ may refer to household pets, such as cats, dogs, rabbits, rodents and animals of the genus Mustela. There are a range of embodiments described herein which provide animal feed products suitable for consumption by different types of animals. For instance, products according to some embodiments are suitable for consumption by carnivorous animals. As used herein, ‘carnivorous animal’ or ‘carnivore’ refers to any animal which eats meat. Meat may form part or all of such an animal's diet. Accordingly, as used herein, ‘carnivore’ includes omnivores. Products according to other embodiments are suitable for consumption by non-carnivorous animals (that is, herbivorous or vegetarian animals).

The term ‘feed component’ refers to any material which is suitable for consumption by animals. Feed component may refer to one feed component, or more than one feed component. In some embodiments suitable for consumption by non-carnivorous animals, the feed component may comprise or consist of a non-meat component. For example, the feed component may comprise at least one of alfalfa meal, pasture grass, linseed, linseed oil, mint, blueberry, cranberry, apple, pear, spinach, broccoli, kale, short cut grass, Lucerne, hay, straw, oat fibre, beet pulp, pea, tomato, chicory, carrot, garlic, lentils, pumpkin, yam any other fruits or vegetables, and vitamins and minerals (further described below). In another embodiment the feed component comprises at least one of alfalfa meal, pasture grass, linseed, linseed oil, mint, vitamins and minerals. In another embodiment the feed comprises at least one of blueberry, apple, spinach, broccoli, and kale. Such feed components may be dried or fresh.

In some embodiments suitable for consumption by carnivorous animals, the feed component may comprise or consist of a meat component. As used herein, the term ‘meat component’ refers to any matter directly obtainable from the carcass of an organism of the kingdom Animalia. In some embodiments, a meat component may comprise mammal matter, bird matter, fish matter, crustacean matter, or a combination thereof. Suitable mammal matter may comprise material from sheep (including lamb and mutton), cattle (including beef) or swine, for example. Suitable bird matter may comprise material from chicken, turkey or duck, for example. Suitable fish matter may include fish meat and fish meal, and may comprise material from white fish, salmon, mackerel, sardine, trout, herring, or tuna, for example. Suitable crustacean matter may comprise material from lobster or crab, for example. In particular embodiments, the meat component comprises matter from turkey and/or beef. Such feed components may be dried or fresh. The meat component may or may not comprise bone matter. For example, the meat component may comprise bone meal. In other examples, the meat component may comprise mechanically deboned meat.

In some embodiments, the feed component may consist essentially of a meat component. In other embodiments, the feed component may consist essentially of a non-meat component. In some embodiments, the feed component may consist of a meat component and a non-meat component, the non-meat component being selected from the whole range of non-meat components defined and described herein. In some embodiments, the feed component may consist of a meat component and a non-meat component, the non-meat component consisting only of vitamins and/or minerals, and excluding any other non-meat components as defined and described herein.

The animal feed product may comprise meat component in an amount of from 2 to 98%, or from 5 to 98%, or from 10 to 98%, or from 20 to 95%, or from 30 to 90%, or from 35 to 80%, or from 40 to 70% by dry weight of the animal feed product. The animal feed product may comprise at least about 2%, 5%, 10%, 15%, 20%, 25%, 30%, 40%, 50%, 60%, 70%, 80% or 90% meat component by dry weight of the animal feed product. The animal feed product may comprise less than about 98%, 95%, 90%, 80%, 70%, 60%, 50%, 40%, 30% or 20% meat component by dry weight of the animal feed product.

The animal feed product according to the present invention comprises a whole-plant component. As used herein, “whole-plant component” refers to a processed plant product, wherein none of the plant's components are discarded during the process; the whole-plant component comprises all of the components or derivatives of the components of the original plant material. Such a whole-plant component may exhibit binding activity in an animal feed component. It may be included in an animal feed product in place of known refined binders, such as starch and/or gluten. The whole-plant component may derive from plant material, for example from an intact or unrefined plant material.

‘Plant material’ refers to material from organisms of the kingdom Plantae. The term plant material as used herein may refer to an entire plant, or a part of a plant. In some embodiments, the plant material is the seed of a plant. In other embodiments, the plant material is the bark of a plant. In other embodiments, the plant material is the root of a plant. In one embodiment, the plant material may be intact; that is, it has not been mechanically processed or chemically extracted. The term ‘intact’ refers to an untreated part of a plant, and does not necessarily refer to the entire plant. Examples of intact plant materials include the leaf, stem or seed of a plant. In another embodiment, the plant material may be unrefined; that is, it may have been exposed to mechanical processing, but it has not been chemically extracted. In some embodiments, the unrefined plant material may be milled, ground, micronized, cracked, rolled or flaked.

‘Plant material residue’ refers to plant material from which a component has been at least partially extracted. The plant material residue may be insoluble in aqueous solvent.

The whole-plant component may derive from an intact or unrefined plant material comprising at least one hydrocolloid precursor. ‘Hydrocolloid precursor’ refers to a material which, when added to water, can provide a hydrocolloid system. ‘Hydrocolloid’, or ‘hydrocolloid system’ refers to a colloidal suspension of particles, wherein the continuous phase comprises water. Further, the dispersed phase (particles) comprise hydrophilic polymers.

In a particular embodiment, an intact or unrefined plant material comprising at least one hydrocolloid precursor may be treated with an aqueous solvent to extract hydrocolloid precursor and thereby provide a hydrocolloid system and a plant material residue; the whole-plant component corresponding to this method thus comprises a hydrocolloid precursor, or a derivative of a hydrocolloid precursor, and a plant residue.

The animal feed product according to the present invention may comprise whole-plant component in any suitable amount for binding the components of the animal feed product together. For example, the animal feed product may comprise whole-plant component in an amount from 0 to 20%, or from 0.5 to 15%, or from 1 to 10%, or from 2 to 8% by dry weight of the animal feed product. The animal feed product may comprise at least about 1%, 2%, 5%, 10%, 15%, or 20% whole-plant component by dry weight of the animal feed product. The animal feed product may comprise less than about 20%, 15%, 10%, 8% or 5% whole-plant component by dry weight of the animal feed product. In a preferred embodiment, the whole-plant component derives from a mucilaginous plant material.

In some embodiments, the plant material is a mucilaginous plant. In some embodiments, the plant material comprises at least one of: psyllium or other plantain, linseed (also referred to as flax), fenugreek, slippery elm, guar, marshmallow, liquorice, cactus, aloe vera, cassava, mallow, okra, chai, Irish moss, Chinese yam, kelp, verbascum, sundews, parthenium, butterwort, mulukhiyuh, hibiscus, locust bean, tara, and spinach.

As used herein, “plantain” refers to plants of the genus Plantago. For the avoidance of doubt, “plantain” as used herein does not refer to cooking bananas of the genus Musa. An example of a suitable plantain for use with the present invention is commercial psyllium. As used herein, “psyllium” refers to plants of the subgenus Psyllium, including species such as Plantago afra L. (African plantain, or black psyllium), Plantago arenaria Waldst. & Kit. (branched plantain, also known as French psyllium or sand plantain), Plantago lanceolate L. (buckhorn, also known as ribgrass, or ribwort), Plantago ovata Forssk. (blond psyllium, also known as blond plantain, ispaghul, isabgol, or desert Indianwheat), Plantago sempervirens Crantz (evergreen plantain, also knowns as shrubby plantain), among others. Any part of the psyllium plant may be used. In some embodiments, the plant material may comprise psyllium seed. In other embodiments, the plant material may comprise psyllium seed husk (that is, husk which has been mechanically separated from the psyllium seed). Suitable psyllium seed husk may be purchased as Metamucil® from the vendor Proctor & Gamble.

In other embodiments, the plant material comprises at least one of: psyllium seed husk or other plantain, linseed seed, fenugreek seed, slippery elm bark, guar beans, marshmallow root, liquorice root, cactus, aloe vera, cassava, mallow leaves, okra seed pod, chai seeds, Irish moss, Chinese yam, kelp, verbascum, sundews, parthenium, butterwort, mulukhiyuh, hibiscus, guar, locust bean, tara seeds, and spinach leaves.

In another embodiment, the plant material comprises at least one of: fenugreek, linseed, liquorice, marshmallow, okra, psyllium, slippery elm, spinach, and mixtures thereof.

In another embodiment, the plant material comprises at least one of: fenugreek seed, linseed seed, liquorice root, marshmallow root, okra seed pod, psyllium seed husk, slippery elm bark, spinach leaf, and mixtures thereof.

In another embodiment the plant material comprises at least one of psyllium, linseed, fenugreek, and slippery elm. In another embodiment, the plant material comprises at least one of psyllium seed husk, linseed seed, fenugreek seed, and slippery elm bark.

In another embodiment the plant material comprises spinach. The plant material may, for example, comprise spinach leaves. In one embodiment, the plant material may essentially consist of spinach.

In another embodiment the plant material comprises both psyllium and linseed. In a further embodiment, the plant material comprises both psyllium seed husk and linseed seed. In another embodiment, the plant material comprises both fenugreek and slippery elm. In a further embodiment, the plant material comprises both fenugreek seed and slippery elm bark.

In another embodiment the plant material comprises guar. In another embodiment the plant material comprises psyllium, in particular blond psyllium. In a further embodiment, the plant material consists of psyllium, in particular blond psyllium.

The animal feed product may be bound together by a whole-plant component comprising a polysaccharide, or a mixture of polysaccharides (the term polysaccharide includes oligosaccharides with at least three or more monomer units). Further, in some embodiments the whole-plant component may comprise a non-starch polysaccharide or mixture of non-starch polysaccharides. In some embodiments the whole-plant component may comprise, for example, a galactomannan, a carrageenan, or a xylan (such as arabinoxylan). In a particular embodiment, the whole-plant component comprises an arabinoxylan.

The animal feed products according to the present invention may have a low starch and/or sugar content (whereby ‘sugar’ is taken to mean mono- and disaccharides). In some embodiments the starch or sugar content of the product is an insufficient amount to function as a whole-plant component in the feed product. In one embodiment, the animal feed product contains less than 10%, or 9%, or 8%, or 7%, or 6%, or 5%, or 4%, or 3%, or 2%, or 1%, or 0.5% starch (w/w). In another embodiment, the animal product has a starch content of from 0 to 10%, or from 0 to 5%, or from 0 to 2% (w/w). In a further embodiment, the animal feed product contains less than 10%, or 9%, or 8%, or 7%, or 6%, or 5%, or 4%, or 3%, or 2%, or 1%, or 0.5% mono- or disaccharides (w/w). In a still further embodiment, the animal feed product has a mono- or disaccharide content of from 0 to 10%, or from 0 to 5%, or from 0 to 2% (w/w).

The animal feed products according to the present invention may have a low gluten content. In some embodiments, the animal feed product has a gluten content of 0 to 2.5%, or from 0 to 1%, or from 0 to 0.5% (w/w). The animal feed product may have a gluten content of less than 2.5%, or less than 2%, or less than 1.5%, or less than 1%, or less than 0.5%, or less than 0.1% (w/w). The animal feed product may have a gluten content of more than 0.1%, or more than 0.5% (w/w). In some embodiments, the animal feed product is essentially free from gluten.

In some embodiments, the animal feed product has a moisture content of from 0 to 30%, or from 3 to 20%, or from 5 to 15%, or from 10 to 14% (w/w). The animal feed product may have a moisture content of less than 30%, or 20% or 15% (w/w). The animal feed product may have a moisture content of more than 0%, or more than 5%, or more than 10% (w/w). According to one aspect of the present invention, the animal feed product may be referred to as a dry pet food.

The animal feed product may have a fat content of less than 50%, or 40%, or 30%, or 20%, or 10% by dry weight of the animal feed product. The animal feed product may have a fat content of at least about 5%, 10%, 15%, 20%, 30% or 40% by dry weight of the animal feed product. The animal feed product may have a fat content of from 0 to 50%, or from 5 to 40%, or from 10 to 30% by dry weight of the animal feed product. The term “fat” is inclusive of oils and refers to glyceryl esters of fatty acids. Suitable fats and oils are feed grade water insoluble fats and oils from animal and vegetable sources which can be liquids or solids at room temperature. Either a single fat or oil or mixtures of fats and/or oils may be employed. Suitable fats include soybean oil, cottonseed oil, coconut oil, rapeseed oil, peanut oil, olive oil, palm oil, sunflower seed oil, rice bran oil, corn oil, sesame seed oil, whale oil, fish oil, lard, tallow, and the like. In some embodiments of the present invention, the fat content may be provided in whole or in part by a feed component(s). That is, the feed components of the animal feed product may comprise fat. Both meat and non-meat components may comprise fat. In some embodiments, the feed component may be a high fat feed component; that is, the feed component may have a high fat content. In particular, the feed component may be a high fat meat feed component. High fat meat feed components may include, for example, mechanically deboned meat.

In some embodiments, fat may be applied to the surface of the animal feed product. That is, the animal feed product may have a surface coating comprising fat. Such a fat coating may improve the palatability of the animal feed product.

Another aspect of the present invention is a method of producing an animal feed product, the method comprising:
(a) treating an intact or unrefined plant material comprising at least one hydrocolloid precursor with an aqueous solvent to extract hydrocolloid precursor and thereby provide a hydrocolloid system and a plant material residue;
(b) mixing the hydrocolloid system containing the plant material residue with feed component to provide a feed mixture;
(c) forming the feed mixture into a product shape, and
(d) drying the product shape to provide the animal feed product.

In some embodiments, the hydrocolloid precursor comprises a polysaccharide, or a mixture of polysaccharides (the term polysaccharide includes oligosaccharides with at least three or more monomer units). Further, in some embodiments, the hydrocolloid precursor comprises a non-starch polysaccharide or mixture of non-starch polysaccharides. In some embodiments the non-starch polysaccharide may comprise, for example, a galactomannan, a carrageenan, or a xylan (such as arabinoxylan). In a particular embodiment, the hydrocolloid precursor comprises an arabinoxylan.

It has been found that the methods described herein allow the production of a food product wherein the feed components are bound together without the need to include any additional starch, sugar (mono- or disaccharides), or gluten products, and without use of synthetic binders. The hydrocolloid system may act as a binder in the production of an animal feed product. Without being bound by theory, it is believed that during the method of the present invention, the hydrocolloid precursors cross-link with each other, thereby producing a binding effect in the animal feed product. In particular embodiments, the hydrocolloid precursors may contain ferulic acid moieties connected thereto via an ester linkage, and the cross-linking may take place between the ferulic acid moieties of the polysaccharide hydrocolloid precursors. Again, without being bound by theory, it is believed that in the heating of hydrocolloid systems according to the present invention, such cross-linking may result in a binding effect being exhibited during the heating. That is, at least some binding effect may be exhibited by the hydrocolloid system before it cools.

The hydrocolloid system used in step (b) contains the plant material residue. Surprisingly, it has been found that the hydrocolloid system which results from treating plant materials with an aqueous solvent as described herein may be used to bind the feed components of an animal feed product, without having to remove any of the insoluble components from the hydrocolloid system, nor purifying the hydrocolloid precursor itself from the mixture. That is, there is no need to add or remove components from the hydrocolloid system provided in step (a) before carrying out step (b). This may result in providing a more efficient method of providing an animal feed product.

The aqueous solvent is any aqueous solvent which can be used to extract hydrocolloid precursor from within a plant material into the solvent system to provide a hydrocolloid system. In some embodiments the aqueous solvent is non-toxic. In another embodiment, the aqueous solvent essentially consists of water. In other embodiments, the aqueous solvent does not comprise alcohol solvents, as this can result in the precipitation of the hydrocolloid precursor from the hydrocolloid suspension.

In some embodiments, the treatment in step (a) is carried out at a temperature of from 25° C. to 150° C., or from 40° C. to 120° C., or from 50° C. to 100° C., or from 60° C. to 90° C. In other embodiments, the treatment in step (a) is carried out at a temperature greater than or equal to 25° C., or 35° C., or 50° C., or 60° C., or 70° C., or 80° C. In other embodiments the treatment in step (a) is carried out at a temperature equal to or less than 150° C., or 130° C., or 110° C., or 100° C., or 90° C., or 80° C., or 70° C., or 60° C. It has been found that, whilst it is possible to carry out the treatment at a temperature of below 40° C. in order to extract the hydrocolloid precursor from within the plant material, it is far more effective to carry out the treatment at a temperature greater than or equal to 40° C. The aqueous solvent may be in any physical form. In some embodiments, the aqueous solvent is liquid or gaseous. If the aqueous solvent consists of water, the solvent may be liquid water or steam.

The extraction solvent may be heated before treating the plant material, and the plant material subsequently treated with the heated extraction solvent with no further heating. In another embodiment, the plant material and extraction solvent are heated together. In another embodiment, the extraction solvent may be heated before treating the plant material, and then the plant material and extraction solvent are heated together. Heating may be carried out according to any method known in the art. Such methods include, but are not limited to, heating on a hotplate, heating in a jacketed vessel or mixer, heating with a heat exchanger, heating in an extruder, or heating in a preconditioner.

The extraction solvent may be of any pH. In some embodiments, the extraction solvent pH is from pH 7 to pH 12, or from pH 8 to pH 10. In some embodiments, the extraction solvent is a buffered solution with a pH of from pH 7 to pH 12, or from pH 8 to pH 10. In other embodiments, the extraction solvent pH is from pH 2 to pH 7, or from pH 3 to pH 6. In some embodiments, the extraction solvent is a buffered solution with a pH of from pH 2 to pH 7, or from pH 3 to pH 6.

‘pH modifier’ refers to one or more chemical compounds used to affect the pH of the extraction solvent. The pH modifier may be any chemical compound capable of achieving the desired pH. pH modifier may be added to the solvent at any stage of the process, such as before treating the plant material with the solvent, or after treating the plant material with the solvent. In some embodiments, the pH modifier is a base, preferably a water-soluble base. In other embodiments, the pH modifier is an acid, preferably a water soluble acid. The pH modifier is also preferably safe for consumption by animals. In some embodiments, the pH modifier may comprise at least one of NaHCO3, Na2CO3 or any other basic inorganic compound. In other embodiments, the pH modifier may comprise at least one of citric acid, acetic acid, tartaric acid, malic acid, lactic acid, fumaric acid, phosphoric acid, or any other suitable acidic compound. In some embodiments, the pH modifier does not comprise an Arrhenius base (a base which dissociates in water to form hydroxide ions).

In embodiments wherein the feed component comprises a meat component, the meat component may be in any suitable physical form. In some embodiments, the meat component is minced/ground, or made into a powder. As such, the meat component may comprise a plurality of meat component particles. In some embodiments, it may be advantageous for the meat component particles to have a mean average diameter equal to or less than 3 mm, or 2 mm, or 1 mm In some embodiments, the meat component particles may have a mean average diameter greater than 0.05 mm, or 0.1 mm, or 0.5 mm, or 1 mm, or 2 mm In some embodiments, the meat component particles may have a mean average diameter of from 0.05 mm to 3 mm, or from 0.1 mm to 2 mm, or from 0.5 mm to 1 mm.

In some embodiments, the meat component may be raw. That is, the meat component has not been cooked or in any way treated so as to irreversibly denature enzymes therein prior to its use in the method of the present invention. In other embodiments, the meat component may be cooked prior to its use in the method of the present invention. The meat component may be cooked by any appropriate method. For example, the meat component may be baked, boiled, grilled, rendered, or fried. In other embodiments, the meat component may be dried, or partially dried. The meat component may be dried by any appropriate method. For example, the meat component may be dried or partially dried in a dehydrator, or by sun drying, freeze drying and ambient drying.

Surprisingly, the method of the present invention has been found to be particularly effective for manufacturing animal feed products from feed mixtures with a high raw meat content, which may otherwise be difficult to manufacture because of the high moisture and/or fat content associated with a high raw meat content. In some embodiments according to the method of the present invention, the feed component may have a raw meat content of more than or equal to 20% by dry weight of the feed component, or more than or equal to 30%, or 40%, or 50%, or 60%, or 70%, or 80%, or 90%, or 95%. In some embodiments, the feed component may essentially consist of raw meat.

The meat component may have a moisture content of from 0 to 90%, or from 15 to 85%, or from 30 to 80%, or from 40 to 75%, or from 50 to 70% (w/w). In some embodiments, the meat component has a moisture content of at least about 5%, 10%, 15%, 20%, 30%, 40%, 50%, 60%, or 70% (w/w). In other embodiments, the meat component has a moisture content of less than about 60%, 50%, 40%, 30%, 20%, 15%, 10%, or 5% (w/w).

The meat component may have a fat content of less than 60%, 50%, 40%, 30%, or 20%, or 10%, or 5% by dry weight of the meat component. The meat component may have a fat content of at least about 5%, 10%, 15%, 20%, 30%, 40% or 50% by dry weight of the meat component. The meat component may have a fat content of from 0 to 60%, or from 5 to 45%, or from 10 to 30% by dry weight of the meat component.

The present method has also been found to be particularly effective for manufacturing feed products from feed mixtures comprising high-moisture non-meat feed components. In particular, the present method may be used to provide feed products from raw non-meat components. The non-meat feed component may have a moisture content of from 0 to 98%, or from 15 to 85%, or from 30 to 80%, or from 40 to 75%, or from 50 to 70%. In some embodiments, the non-meat feed component has a moisture content of at least about 5%, 10%, 15%, 20%, 30%, 40%, 50%, 60%, 70%, or 80%, or 90% (w/w). In other embodiments, the non-meat feed component has a moisture content of less than about 98%, 95%, 90%, 85%, 80%, or 75% (w/w).

Additionally or alternatively to the pH modifiers described above, further metal salts may be added to the mixture for their mineral content. Such metal salts may assist in binding. In some embodiments, the metal salts may comprise at least one of NaCl, KCl, CaCl2, MgCO3, calcium lactate, CaHPO4, MgO, MgS, K2SO4, FeSO4, ZnO, CuSO4, CoCO3, Ca(IO3), or Na2SeO3. These metal salt minerals may be included in the animal feed product as non-meat feed component.

Vitamins may also be added to the mixture. Any appropriate vitamin or combination of vitamins may be added, for example vitamin A, vitamin B, vitamin C, vitamin D, vitamin E, or vitamin K Similarly, these vitamins may be included in the animal feed product as non-meat feed component. In some embodiments, the feed component may comprise a non-meat component comprising one or more minerals and/or one or more vitamins. In a particular embodiment, the feed component may comprise a non-meat component consisting of one or more minerals and/or one or more vitamins

Antioxidants may also be added to the mixture. As used herein, the term “antioxidant” is preferably understood to include substances that inhibit oxidation or reactions promoted by Reactive Oxygen Species (ROS) and other radical and non-radical species. Additionally, antioxidants are molecules capable of slowing or preventing the oxidation of other molecules. Any appropriate antioxidant may be added, for example carotenoids, coenzyme Q10 (“CoQ10”), flavonoids, goji berry, hesperidine, lignan, lutein, lycopene, polyphenols, selenium, vitamin A, vitamin B1, vitamin B6, vitamin B12, vitamin C, vitamin D, vitamin E, and combinations thereof.

Probiotics may also be added to the mixture. As used herein, the term “probiotic” is preferably understood to include any microorganism that exerts a beneficial effect on the host animal such as increased health or resistance to disease. Any appropriate probiotic may be added, for example yeasts such as Saccharomyces, Debaromyces, Candida, Pichia and Torulopsis, moulds such as Aspergillus, Rhizopus, Mucor, and Penicillium, and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus.

Palatability enhancers (also known as palatants) and/or digestive enhancers may also be added to the mixture. Said enhancers may be included in the feed mixture (i.e. may be disposed within the final animal feed product), or be applied to the animal feed product as a coating (i.e. may be disposed on the surface of the final animal feed product). Suitable palatability enhancers may include digest, such as chicken digest or beef digest. Suitable digestive enhancers may include digestive bacteria, enzymes and/or probiotics.

The feed mixture will have a moisture content provided by the hydrocolloid system and any further water subsequently added. The term ‘moisture content’ refers to the amount of water in the mixture. The moisture content of the feed mixture may be from 5% to 80%. In one embodiment, the moisture content of the feed mixture is from 20% to 80% (w/w total ingredients), or from 30% to 70% (w/w total ingredients), or from 40% to 60% (w/w total ingredients). In another embodiment, the moisture content of the feed mixture is from 5% to 30% (w/w total ingredients), or from 8% to 25% (w/w total ingredients), or from 10% to 18% (w/w total ingredients).

In step (a), treating the plant material with an aqueous solvent may include mixing. The mixing of plant material and aqueous solvent in step (a), and/or the hydrocolloid system and feed components in step (b), can be carried out according to any method known in the art. Such methods include, but are not limited to, using a planetary mechanical mixer, a spiral mechanical mixer, a ribbon blender, a cone screw blender, a counter-rotating blender, a rotary drum blender, an extruder, or a preconditioner. Mixing may also be achieved manually with the use of a spoon.

Step (a) and/or step (b) may be carried out in any appropriate vessel. Such a vessel may include a bowl. In some embodiments a stainless steel bowl may be used. In the embodiments wherein the plant material and aqueous solvent are heated together, the vessel may be a jacketed vessel or mixer. In some embodiments, steps (a) and (b) may be carried out simultaneously.

In some embodiments, the aqueous solvent may be may be provided in step (a) in liquid form to the plant material. Alternatively or additionally, the aqueous solvent may be provided in the feed component—that is, in embodiments wherein steps (a) and (b) are carried out simultaneously, the aqueous solvent may be provided as the moisture of the feed components. In such embodiments, further solvent in liquid form may or may not be added. These embodiments may in particular comprise a raw meat feed component. For example, it may be possible to manufacture an animal feed product with an intact or unrefined plant material and a raw meat feed component, wherein no further solvent in liquid form is added to the mixture—the water present in the raw meat feed component may be sufficient to extract the hydrocolloid precursor from the intact or unrefined plant material.

The feed mixture can be shaped to provide a product shape according to any method known in the art. Such methods include, but are not limited to, moulding, pressing, deposition, and extrusion. In this context the term “extrusion” includes pelletisation. Some moulding methods can be carried out with a rotary moulder. Some pressing methods can be carried out with food forming machines, such as may be used to make a variety of food forms such as hamburger patties, and generally refers to a machine in which the feed mixture is pressed into a mould plate and then the product shapes formed are subsequently knocked out of the mould. Some depositing methods can be carried out with a depositor. Some extrusion methods can be carried out with single screw extruders, twin screw extruders, or pelletizers. Shaping the feed mixture may also be carried out with food wire cut machines, sheet formers, or rotary cutters. More than one method and/or device for carrying out such a method may be used. In particular, forming the feed mixture may first comprise any of the above methods (such as moulding, pressing, depositing or extruding), and then cutting the resulting shaped composition to provide a product shape.

A single screw extruder as contemplated herein uses a screw to push a mixture through a die to provide an extrudate. The screw may be narrower towards the die-end of the extruder. This may result in an increase of pressure on the mixture in the extruder, and thereby increase the temperature of the mixture. The extrudate may be further processed after passing through the die, for example the extrudate may be cut into sections.

A twin screw extruder as contemplated herein comprises two screws. Said screws may be intermeshing or non-intermeshing screws. Said screws may be co-rotating or counter-rotating. Said screws are used to push a mixture through a die to provide an extrudate. A twin screw extruder may be suitable to transport, compress, mix, cook, shape and shear the feed mixture. A twin screw extruder may exhibit superior mixing and heating of components in the feed mixture when compared to a single screw extruder. The extrudate may be further processed after passing through the die, for example the extrudate may be cut into sections.

Both single screw extruders and twin screw extruders may be used in conjunction with a preconditioner. A preconditioner may be used to mix components in the mixture, and provide aqueous solvent to the mixture before passing the mixture into the extruder. The preconditioner may also be used to provide heat to the mixture before passing the mixture into the extruder.

The product shape can be dried to provide the animal feed product according to any method known in the art. Such methods include, but are not limited to, baking, extrusion cooking, food drying, convection drying, microwave oven drying, sun drying, freeze drying, ambient drying and dehydrating. In one embodiment, a dehydrator is used in order to dehydrate the product shape.

In one embodiment the drying is carried out at a temperature from 25° C. to 150° C., or from 40° C. to 120° C., or from 40° C. to 100° C., or from 40° C. to 90° C., or from 50° C. to 80° C., or from 60° C. to 70° C. In other embodiments, the drying is carried out at a temperature greater than or equal to 25° C., or 35° C., or 50° C., or 60° C., or 70° C., or 80° C., or 100° C. In other embodiments the aqueous solvent is at a temperature equal to or less than 150° C., or 120° C., or 100° C., or 90° C., or 80° C., or 70° C., or 50° C. Especially where the feed mixture is of a low moisture content, such as from 10% (w/w total ingredients) to 18% (w/w total ingredients), or where the product shape is particularly thin, it may be appropriate for the drying to be carried out at a temperature from 25° C. to 40° C.

In some embodiments the feed mixture may be subjected to extrusion cooking, thereby carrying out steps (c) and (d) simultaneously.

In one embodiment, steps (a) to (d) are carried out in a continuous process. For example, when using the extrusion method, the plant material and aqueous solvent may be added to a reaction vessel along with the feed components, and the entire mixture heated whilst being extruded through the extruder to a drying mechanism. The entire process is continuous.

It has been found that products made according to this method are surprisingly resilient to wet conditions, and retain their structural integrity after prolonged submersion in water. The product described above is more resistant to wet or moist conditions than analogous animal feed products containing starch, sugar or gluten binders, which would be advantageous in situations such as where the animal feed product is stored outside.

In another aspect of the present invention, there is provided a method of feeding a carnivorous animal comprising providing a processed and formed animal feed product and feeding said feed product to said animal. The animal feed product comprises a feed component which includes a meat component. The meat component is present in an amount of from 2 to 98% by dry weight of the animal feed product. Further, the animal feed product has a starch content of from 0 to 10% by dry weight of the animal feed product, and a moisture content of from 0 to 30% by weight. Further still, the animal feed product includes a whole-plant component derived from an intact or unrefined plant material comprising at least one hydrocolloid precursor.

The carnivorous animal of the method described above may be any non-human animal, such as a fish, an amphibian, a reptile, a bird, or a non-human mammal. In some embodiments, the carnivorous animal may be a non-human mammal. In some embodiments, the animal may be a household pet. In particular, the carnivorous animal may be a cat or a dog.

Surprisingly, it has been found that an animal feed product as described above can be provided for feeding to a carnivorous animal. Moreover, it is surprising that an animal feed product of said composition is palatable for carnivorous animals.

### EXAMPLES

### Example 1

3,000 mL of water was heated to 90° C. in a kettle, then added to 1,000 g of micronised linseed and 130 g of ground psyllium husk in a stainless steel bowl, and stirred for 2 minutes with a mechanical mixer. Subsequently 1,000 g of ground pasture grass, 1,105 g of ground alfalfa, 474 g of mint, 631 g of calcium carbonate, and 200 g of linseed oil were added and mixed until fully dispersed. The mixture was then formed into biscuits with a food forming machine and dehydrated at 68° C. for 12 hours.

### Example 2

400 mL of water was added to 9 g of ground fenugreek seed and 9 g of powdered slippery elm bark and the mixture was stirred on a hotplate with a mechanical mixer at 100° C. for 5 minutes in a stainless steel bowl. Subsequently 0.4 g of sodium bicarbonate was added, followed by 0.40 g of calcium chloride, and 300 g of ground alfalfa, and the mixture stirred. The resulting mixture was formed into biscuits with a food forming machine and dehydrated at 68° C. for 12 hours.

### Example 3

7.5 kg of ground psyllium husk, 12 kg of linseed oil, 30 kg of ground fenugreek seeds, 30 kg of an herb mix, 75 kg of micronised linseed, 30 kg of calcium carbonate, and 115.5 kg of alfalfa meal were ground together to a particle size of 3 mm, and charged into a conditioner. A mixture of water and steam at 90° C. was added to the conditioner at a rate of 40% (w/w total ingredients), and then the mixture was passed into a single screw extruder. The extrudate formed was passed through a knife matrix and cut into short cylindrical product shapes. The product shapes were then dried on a belt drier at 90° C. for between 1 and 2 hours.

### Example 4

410 g of turkey mince was cooked and subsequently blended into fine particles. 40 g of fresh blueberries, 40 g of fresh apple, 10 g of dried spinach powder, 10 g of dried broccoli powder, 2.1 g of sodium chloride, 1.2 g of sodium bicarbonate, 10 mL of olive oil, 5 g of psyllium husk powder, 2.2 g of fenugreek seed powder and 6 g of micronized linseed were added to the blended turkey, and the resulting mixture blended to an even consistency. 250 mL of boiling water was added, and the mixture blended at 70° C. until thick to provide a dough. The dough was subsequently rolled out and cut into forms, which were then dried at 78° C. until dry.

Example 4 illustrates animal feed products with a high meat content.

### Durability Rating Method

Between 5 and 10 g of whole animal feed products was added to a ball jar. The lid of the ball jar was latched, and the ball jar shaken for 90 seconds. The mass of the resulting whole animal feed products (that is, the unbroken, complete animal feed products) was measured. The durability rating is a percentage calculated by dividing the mass of the resulting whole animal feed products by the mass of the starting whole animal feed products, and multiplying by 100. In this example, the durability rating was 97.6%.

### Example 5

96 g of 10% fat minced beef was blended until smooth. 1.2 g of powdered psyllium husk was added, and the resulting mixture blended to an even consistency. This mixture was heated in a water bath at 70° C., and then formed into balls by hand and dried at 110° C.

Example 5 illustrates animal feed products with high fresh meat content.

### Example 6

20 g of spinach powder, 20 g of egg white powder, 20 g of pea protein, 20 g of brown rice protein and 20 g of soya protein was mixed with 3 g of psyllium husk powder and 6 g of olive oil. 200 mL of 90° C. water was added to the resulting mixture, and then mixed to a uniform consistency. The mixture was shaped into forms and dried at 90° C.

Example 6 illustrates non-meat, high protein animal feed products.

### Example 7

50 g of 20% fat minced beef was cooked and subsequently blended into fine particles. 6 g of fresh blueberries, 6 g of fresh apple, 6 g of fresh kale, 5 g of fresh broccoli and 5 g of dried spinach powder were added to the beef, and the mixture blended. 20 g sodium chloride, 20 g of calcium chloride, 0.4 g of sodium bicarbonate, 3 g of psyllium husk powder, 0.7 g of fenugreek seed powder and 2 g of micronized linseed were added, and the resulting mixture blended to an even consistency. 60 mL of boiling water was added and the mixture blended until thick to provide a dough. The resulting dough was subsequently rolled out and cut into forms, which were then dried at 78° C. until dry.

Example 7 illustrates animal feed products with a high mineral content.

Durability rating: 88.8%

### Example 8

114 g of 20% fat beef mince was cooked and subsequently blended into fine particles. 10 g of fresh broccoli, 10 g of fresh blueberries, 10 g of fresh apple and 10 g of fresh kale were added to the beef, and the mixture blended. 0.6 g of sodium chloride, 0.3 g of sodium bicarbonate, 3 g of psyllium husk powder, 0.7 g of fenugreek seed powder and 2.1 g of micronized linseed were added, and the resulting mixture was blended to an even consistency. 18 mL of boiling water was added and the mixture blended until thick to provide a dough. The resulting dough was subsequently rolled out and cut into forms, which were then dried at 78° C. until dry.

Example 8 illustrates animal feed products with a high fat content.

Durability rating: 87.9%

### Example 9

51 g of cooked turkey mince was blended until fine. Subsequently, 2.5 g of dried spinach powder, 2.5 g of dried broccoli powder, 0.6 g of sodium chloride, 10 g of fresh blueberries, 10 g of fresh apple, 1 g of olive oil and 36 mL of lemon juice were added to the turkey and the resulting mixture blended until fine. 1.5 g of micronized linseed, 0.5 g of fenugreek and 1.5 g of powdered psyllium husk were added, and mixed thoroughly. 20 mL of 90° C. water was added, and the resulting mixture mixed until thick, and then heated to 70° C. to provide a dough. The dough was then rolled out and cut into forms. Half of the forms were dried at 78° C. until dry; half of the forms were dried at 150° C. until dry.

Example 9 shows an animal feed product manufactured under acidic conditions.

### Example 10

53 g of cooked turkey mince was blended until fine. Subsequently, 2.5 g of dried spinach powder, 2.7 g of dried broccoli powder, 0.6 g sodium chloride, 3.6 g of sodium carbonate, 10 g of fresh blueberries, 10 g of fresh apple and 1 g of olive oil were added to the turkey and the resulting mixture blended until fine. 1.5 g of micronized linseed, 0.5 g of fenugreek and 1.5 g of powdered psyllium husk were added, and mixed thoroughly. 20 mL of 90° C. water was added, and the resulting mixture mixed until thick, and then heated to 70° C. to provide a dough. The dough was then rolled out and cut into forms. Half of the forms were dried at 78° C. until dry; half of the forms were dried at 150° C. until dry.

Example 10 shows an animal feed product manufactured under alkali conditions.

### Example 11

Samples of mixtures with high or low pH were dried at 150° C. All of the dried samples formed hard, puffed, hollow animal feed products. These animal feed products were significantly more durable than animal feed products resulting from samples of mixtures with neutral pH dried at 150° C.

### Example 12

3,000 g of fresh turkey mince was mixed with 320 g of dried spinach powder, 320 g of dried broccoli powder, 19 g of sodium chloride, 44 g of linseed meal, 20 g of fenugreek powder, 86 g of psyllium husk powder and 30 mL of lemon juice. The mixture was then extruded through a Werner Pfleiderer, Continua 37 twin screw extruder, and the extrudate dried at 68° C.

Example 12 shows an animal feed product manufactured with a high raw meat content in a Werner Pfleiderer, Continua 37 twin screw extruder.

### Example 13

6,000 g of fish meal, 215 g of dried spinach powder, 215 g of dried broccoli powder, 34 g of sodium chloride, 179 g of linseed, 89 g of fenugreek seed powder and 358 g of psyllium husk powder was mixed with 2,000 mL water heated to 90° C. The resulting mixture was extruded through a Werner Pfleiderer, Continua 37 twin screw extruder. The extruder barrel was heated to 90° C. and 120° C. in the first and second sections, respectively. The extrudate was pelletised and dried at 68° C.

Durability test rating: 95%

### Example 14a

200 g of cooked turkey mince was mixed with 6 g of dried spinach powder at 15° C. The mixture was blended, moulded into forms and dried at 68° C.

### Example 14b

200 g of cooked turkey mince was mixed with 6 g of dried spinach powder at 40° C. The mixture was blended, moulded into forms and dried at 68° C.

### Example 14c

200 g of cooked turkey mince was mixed with 6 g of dried spinach powder at 50° C. The mixture was blended, moulded into forms and dried at 68° C.

### Example 14d

200 g of cooked turkey mince was mixed with 6 g of dried spinach powder at 15° C. The mixture was blended, moulded into forms and dried at 120° C.

### Example 14e

200 g of cooked turkey mince was mixed with 6 g of dried spinach powder at 40° C. The mixture was blended, moulded into forms and dried at 120° C.

### Example 14f

200 g of cooked turkey mince was mixed with 6 g of dried spinach powder at 50° C. The mixture was blended, moulded into forms and dried at 120° C.

All of the animal feed products manufactured according to Examples 14a-14f formed products with a high durability rating.

### Example 15

746 g of ground turkey mince, 168 g of meat and bone meal, 3.6 g of pea protein, 15 g of dried spinach powder, 15 g of dried broccoli powder, 2 g of sodium chloride, 9 g of linseed meal, 25 g of psyllium husk powder and 5 mL of lemon juice were combined and mixed together. The resulting mixture was extruded through a Betol 20mm single screw extruder (10 mm circular die), wherein the barrel was heated to 100° C. The extrudate was cut into forms and dried at 68° C.

Example 15 illustrates extruded animal feed products with a high raw meat content.

Durability test rating: >95%

### Example 16

7,600 g of ground turkey breast, 1,680 g of meat and bone meal, 70 g of pea protein, 35 g of soya protein, 150 g of dried spinach powder, 150 g of dried broccoli powder, 20 g of sodium chloride, 90 g of linseed meal, 250 g of psyllium powder, and 100 mL of lemon juice were combined and mixed together. The resulting mixture was extruded through a 40 mm twin screw extruder (10 mm circular die), wherein the barrel was heated to 110° C. The extrudate was cut into forms and dried at 68° C.

Example 16 illustrates extruded animal feed products with a high raw meat content.

Durability test rating: 97%

### Example 17

115 mL of olive oil was added to 999 g of the mixture prepared in Example 16 before extrusion. The resulting mixture was extruded through a 40 mm twin screw extruder (10 mm circular die), wherein the barrel was heated to 110° C. The extrudate was cut into forms and dried at 68° C.

Example 17 illustrates extruded animal feed products with a high fat content.

Durability test rating=85%

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A processed and formed animal feed product comprising a feed component which includes a meat component;
wherein the meat component is present in an amount of from 2 to 98% by dry weight of the animal feed product;
wherein the animal feed product has a starch content of from 0 to 10% by dry weight of the animal feed product, and has a moisture content of from 0 to 30% by weight; and
wherein the animal feed product includes a whole-plant component derived from an intact or unrefined plant material comprising at least one hydrocolloid precursor.

2. The animal feed product according to claim 1, wherein the animal feed product comprises the said whole-plant component in an amount of from 0.1 to 20% by dry weight of the animal feed product.

3. The animal feed product according to claim 1, wherein the intact or unrefined plant material comprises at least one of: fenugreek, linseed, liquorice, marshmallow, okra, psyllium, slippery elm, spinach, and mixtures thereof.

4. The animal feed product according to claim 1, wherein the meat component comprises sheep, cattle, swine, chicken, turkey, duck, white fish, salmon, mackerel, sardine, trout, herring, tuna, lobster, crab, or a combination thereof.

5. The animal feed product according to claim 1, wherein the feed component further comprises a non-meat component comprising at least one of: alfalfa meal, pasture grass, linseed, linseed oil, mint, blueberry, cranberry, apple, pear, spinach, broccoli, kale, short cut grass, Lucerne, hay, straw, oat fibre, beet pulp, pea, tomato, chicory, carrot, garlic, lentils, pumpkin, yam, any other fruits or vegetables, and vitamins and minerals, and mixtures thereof.

6. The animal feed product according to claim 1, wherein the said whole-plant component comprises a non-starch polysaccharide.

7. The animal feed product according to claim 1, wherein the animal feed product contains less than 5% mono- and disaccharides by dry weight.

8. A method of producing an animal feed product comprising:
(a) treating an intact or unrefined plant material comprising at least one hydrocolloid precursor with an aqueous solvent to extract hydrocolloid precursor and thereby provide a hydrocolloid system and a plant material residue;
(b) mixing the hydrocolloid system containing the plant material residue with feed component to provide a feed mixture;
(c) forming the feed mixture into a product shape, and
(d) drying the product shape to provide the animal feed product.

9. The method according to claim 8, wherein the hydrocolloid precursor is a non-starch polysaccharide.

10. The method according to claim 8, wherein the aqueous solvent essentially consists of water.

11. The method according to claim 10, wherein the treatment in step (a) is carried out at a temperature of from 25° C. to 150° C.

12. The method according to claim 8, wherein the plant material comprises at least one of: fenugreek, linseed, liquorice, marshmallow, okra, psyllium, slippery elm, spinach, and mixtures thereof.

13. The method according to claim 8, wherein the feed component consists essentially of a meat component.

14. The method according to claim 13, wherein the meat component has a moisture content of from 0 to 90% by weight.

15. The method according to claim 8, wherein the feed component comprises a meat component and a non-meat component.

16. The method according to claim 15, wherein the meat component has a moisture content of from 0 to 90% by weight.

17. The method according to claim 8, wherein step (c) comprises extruding the feed mixture to provide a product shape.

18. The method according to claim 8, wherein step (c) comprises pressing the feed mixture to provide a product shape.

19. The method according to claim 8, wherein step (d) is carried out at a temperature of from 25° C. to 150° C.

20. The method according to claim 8, wherein steps (a) and (b) are carried out simultaneously.

21. A method of feeding a carnivorous animal comprising providing a processed and formed animal feed product and feeding said feed product to said animal;
the animal feed product comprising a feed component which includes a meat component;
wherein the meat component is present in an amount of from 2 to 98% by dry weight of the animal feed product;
wherein the animal feed product has a starch content of from 0 to 10% by dry weight of the animal feed product, and has a moisture content of from 0 to 30% by weight; and
wherein the animal feed product includes a whole-plant component derived from an intact or unrefined plant material comprising at least one hydrocolloid precursor.
